(19) United States
(12) Patent Application Publication
(10) Pub. No.: US 2013/0036671 A1
(43) Pub. Date: Feb. 14, 2013

(54) Decentralized Hydrocarbon Refining and Distribution

(71) Applicants: Vito R. Saccheri, Houstont, TX (US); Phil De Palm, Houston, TX (US)

(72) Inventors: Vito R. Saccheri, Houstont, TX (US); Phil De Palm, Houston, TX (US)

(21) Appl. No.: 13/205,120

(22) Filed: Aug. 8, 2011

(51) Int. Cl. C10J 3/48; C01B 3/32; C10G 19/00

(52) U.S. Cl. 48/62 R; 196/46; 208/177; 48/127.5

(57) ABSTRACT

A method of refining hydrocarbon material includes transporting a mobile refinery to a harvesting site, at least partially refining raw hydrocarbon material at the harvesting site, and transporting the at least partially refined hydrocarbon material to a remote location. A hydrocarbon material refining system includes a mobile refinery adapted to be transported to a harvesting site and to at least partially refine raw hydrocarbon material at the harvesting site, and a mobile storage module adapted to store the at least partially refined hydrocarbon material for transport to a remote location.

### FIELD OF THE INVENTION

The present invention relates to systems and methods of refining and distributing oil and gas to the regional markets of the oil and gas harvesters. In particular, the present invention relates to systems and methods of refining and distributing stranded oil and gas.

### BACKGROUND OF THE INVENTION

Currently, production of hydrocarbon products such as gasoline and natural gas requires the drilling and eventual refining of raw hydrocarbon materials. Because the drilling for such material usually takes place in remote areas, the raw material first must be harvested, and is then sent through pipeline networks to central hubs, where the materials are refined into marketable products. Thus, large-scale full-sized refineries, chemical and petrochemical plants exist in fixed locations all around the country. In sequence, they process, refine, and produce thousands of products for hundreds of industries. The economic system of the United States is dependent on the continued flow of finished products from this industry. From basic grades of gasoline, fuel oil, heating oils, aviation fuels, diesel oils, asphalts, and various lubricants, to literally thousands of other industry products ranging from cosmetics, plastics, and even tooth paste, the country is dependent on the oil and gas industry. Even the electricity we use is generated by burning refined oil and gas products. It is easy to demonstrate that the process of turning raw hydrocarbon materials into these end products has a great impact on our economy.

While the system described above has worked fine for the better part of ten to twelve decades, it required the construction of an expensive national pipeline system to gather up and deliver the raw hydrocarbon material, such as crude oil, from the various harvesting sites and transport it to the various refineries. In addition, a separate national pipeline system was needed to distribute the refined products to various regions of the country. In most cases, the raw material is piped from a remote production location to a refinery, after which the finished products are piped right back to the original region the raw material came from for distribution and sale. The distance between the production locution(s) and the refinery can be hundreds of miles, and use of the present infrastructure is both costly and inefficient. For example, certain grades of crude oil from Pennsylvania can only be processed at special refineries in Texas. Then, the finished products must be piped all the way back to Pennsylvania for distribution and sale.

Over time, some of the infrastructure has been eroding in place. Also, some refineries and pipelines have been allowed to deteriorate to the point that it is far too costly to keep them operating. As the cost to operate and maintain them continue to escalate, many have simply been shut down. Large producers and distributers have compensated for the expense by reducing the price they're willing to pay to the crude supplier, who can no longer get a decent value for the raw material he is harvesting from the ground.

Further, the aging collection of a limited number of oil and gas refineries has created a phenomenon in oil production known as stranded oil and gas. The term refers to oil and gas deposits that have been found but are left underground for want of transport. Distant oil and gas fields must await the slow expansion of the pipeline infrastructure to an economical market, and are further hampered by the legal barriers to the export of American crude oil. As a result, drillers sit on tapped reserves, their investments unrewarded, at times for years. There is a need in the oil and gas industry for decentralization of the refining process that would allow for quicker shipment of these reserves and return on investment. A system is needed as an alternative to the current costly infrastructure. The alternative system should be inexpensive to implement, and should provide flexibility in the production process, while providing solutions to current inefficiencies that result in stranded resources and raw materials. What is needed is a system that would allow the oil field owner to process and refine his oil and gas directly in the oil fields, then distribute the semi-finished and finished products directly within his own regional market(s), that is, a decentralized approach.

### BRIEF SUMMARY OF THE INVENTION

The present invention is a system that allows an oil field owner to process and refine his oil and gas directly in the oil fields, then distribute the semi-finished and finished products directly within his own regional market(s), that is, a decentralized approach. While the oil and gas industry is used throughout as a non-limiting example, the system and method of the present invention as described herein can be applied to any industry that harvests raw hydrocarbon material to produce consumer goods, or any raw material that is transported via pipeline for refining and production purposes.

The present invention provides for the processing of hydrocarbon materials directly in the field from which it is extracted, such as an oil field. This can be accomplished in three incremental modular stages, for example, using mini processing units. In such a mini processing unit, crude oil is collected, foreign matter is removed, and the crude oil is then separated into the various base products, such as would normally take place in a large plant, as a preparatory stage for further refining. Because the useful life of an oil field is finite, preferably this preparatory stage is small, modular, and mobile, allowing for relocation to another oil field in the future.

An important aspect of the invention is a method of refining hydrocarbon materials using a series of mobile processing units that can be transported to and erected in the oil producing fields. The process begins with one or more mobile “stage 1” preliminary refining unit(s). Raw hydrocarbon material is processed into semi-finished products, which can then be transported to a “stage 2” unit for final refining into marketable products. Some or all of these products can then be transported to other specialty “products plants” (stage 3 units), as demand and marketing conditions require. All mobile units are modular in design and are shipped as needed via transport vehicles(s).

Any unit can be disposed be in the vicinity of existing pipelines so as to facilitate distribution. If no pipelines are available, then products can be distributed by tanker trucks to the end user.

Further aspects of the invention are now described with reference to FIGS. 1-4.

According to an aspect of the invention, a method of refining hydrocarbon material includes transporting 1 a mobile refinery 9 to a harvesting site 4. Raw hydrocarbon material is at least partially refined 2 at the harvesting site 4. The at least partially refined hydrocarbon material is transported 3 to a remote location 7, 8. The harvesting site 4 can be, for example, a drilling site, such as a crude oil drilling site and/or a natural gas drilling site, and the raw hydrocarbon material can be crude oil.

The remote location can be a refinery 7, and the method can also include further refining of the at least partially refined hydrocarbon material at the refinery 7. Alternatively, the remote location can be a sales distribution center 8.

The mobile refiner 5 can be transported by providing a miniature refinery module 9 on a transport vehicle 10.

The at least partially refined hydrocarbon material can be transported by providing a storage module 11 on a transport vehicle 12.

The harvesting site 4 can be located in an area remote from main pipeline access.

The mobile refinery 5 can be transported to a second harvesting site.

According to another aspect of the invention, a hydrocarbon material refining system includes a mobile refinery 5 and a mobile storage module 6. The mobile refinery 5 is adapted to be transported to a harvesting site 4 and to at least partially refine raw hydrocarbon material at the harvesting site 4. The mobile storage module 6 is adapted to store the at least partially refined hydrocarbon material for transport to a remote location. The harvesting site 4 can be, for example, a drilling site, such as a crude oil drilling site and/or a natural gas drilling site, and the raw hydrocarbon material can be crude oil.

The remote location can be a refinery 7 adapted to further refine the at least partially refined hydrocarbon material. Alternatively, the remote location can be a sales distribution center 8.

The mobile refinery 5 can include a miniature refinery module 9 disposed on a transport vehicle 10.

The storage module 11 can be disposed on a transport vehicle 12.

The harvesting site 4 can be located in an area remote from main pipeline access.

The system can also include a second harvesting site.

### BRIEF DESCRIPTION OF THE DRAWINGS

FIG. 1 is a flow diagram of an exemplary embodiment of the invention.

FIG. 2 is a block diagram of an exemplary embodiment of the invention.

FIG. 3 is a diagram of an exemplary mobile mini refinery of the invention.

FIG. 4 is a diagram of an exemplary mobile storage module of the invention.

FIG. 5 is a schematic diagram of exemplary units used in various stages according to the invention.

FIG. 6 is a diagram of a conventional distillation tower.

FIG. 7 is a diagram of an exemplary distillation tower section of the invention.

FIG. 8 is a diagram of a exemplary trailer-mounted distillation tower.

FIG. 9 is an illustration of an exemplary expandable distillation tower.

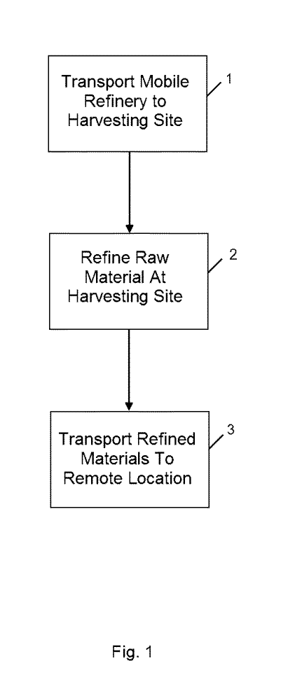

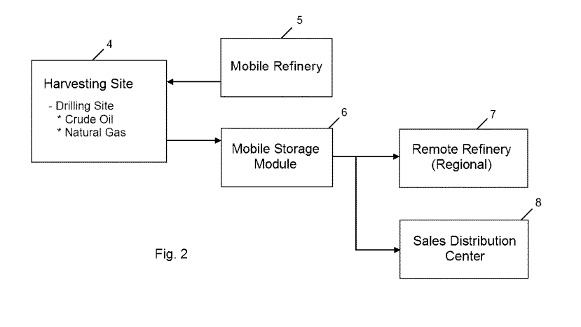

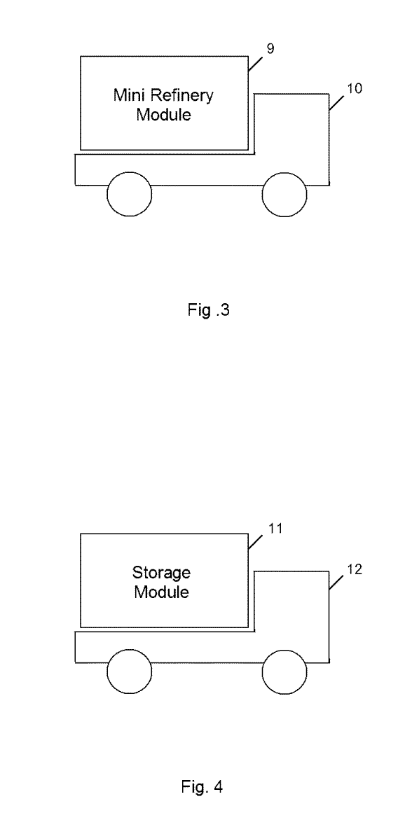

### DETAILED DESCRIPTION OF THE INVENTION

The present invention overcomes the problems inherent in current industry standard practices for the transport and processing of crude oil and other raw materials, through decentralization. According to the invention, at least some of the refining and production aspects of the process can be started in the field, where the raw material is harvested. This can be performed in small modular stages, using miniature processing units. In such a mini processing unit, for example, crude oil can be cleaned and then separated into various base products, as large centralized plants normally do as a preparatory stage for further refining. However, because the useful life of an oil field is finite, this preparatory stage should not only be small and modular, but it preferably is also mobile so that it can be relocated to another oil field or raw material harvest site in the future. Specific process equipment suitable for the preparatory stage is preferably designed and fabricated on skids. The skids are mounted onto special flat bed trailers that are driven and carry the units into the field. A series of trailers, each equipped with different modules, are gathered in the field and parked on a concrete foundation in predetermined areas. Once there, they are interconnected to form a complete functional processing unit. The entire system is sized to accommodate the quantity of raw material produced by the field.

It can be the case that, over time, a harvesting site will grow in capacity. For example, new wells can be added to an oil drilling site. As the addition of new oil wells increases the produced volume of crude, the capacity of the mini processing unit should be increased accordingly. This can be accomplished, incrementally, by adding additional plug-in modules to the processing unit as necessary. In this way, the processing unit can grow on demand. This capability does away with the need to build a large complex at the beginning, when the start-up cost could be too great, and instead allows for a smaller start-up cost and expansion when it is more affordable, that is, after the site has become profitable.

Thus, a preferred embodiment of the present invention is a system for processing crude oil at the drilling site. The system includes a process for partially or completely refining the raw petroleum material at the site and for shipping the refined product or products to the next destination for further refining, sale, or other distribution. The system also includes the mini processing units and other apparatus used to enable refining at the site and distribution from the site, and for portability between sites.

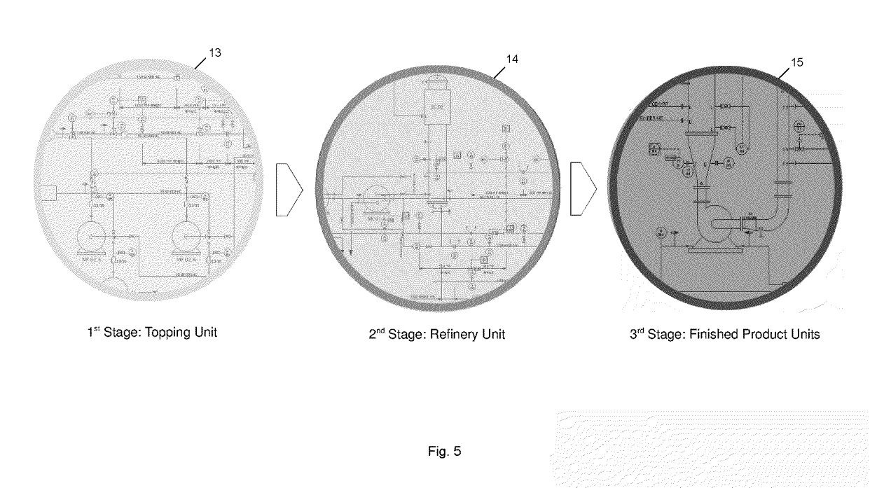

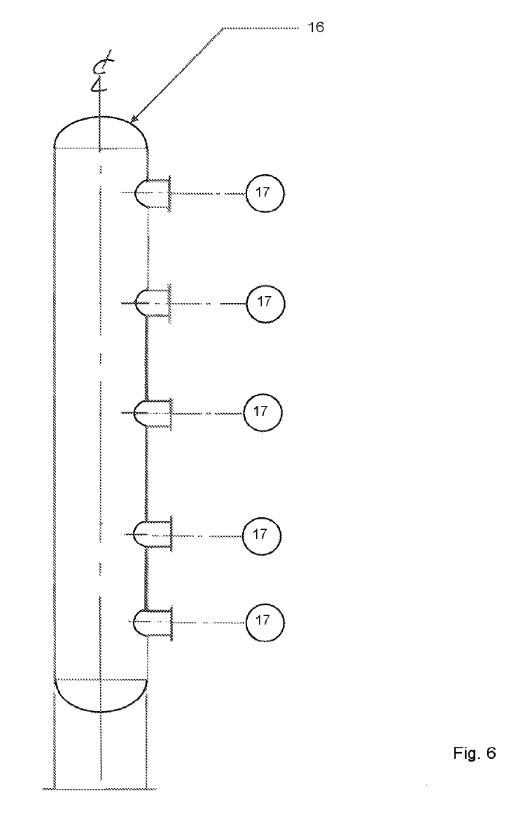

The process of the invention takes place in several stages, and the mini processing unit includes several associated stages, as described below. These stages utilize at least one topping unit 13, refinery nit 14, and finished product unit 15, as shown in FIG. 5.

### The 1st Stage

This stage is commonly performed by a topping unit 13, which is used to partially refine the raw material at the site, which can be further refined, if necessary, or sold as-is, or otherwise distributed. Thus, this allows the harvester the option to at least begin the refining process himself, resulting in a product having a higher value than the raw material he would otherwise have to sell. Subsequently, one or more process streams, that is, levels of refined product, can then be sold at higher prices. Although the process stream is a partially-refined product, that product will still command a higher price at the next-stage refinery, as some of the refining process has already been completed. In any case, the harvester is paid more money than he would receive otherwise.

In addition to increasing revenue from the raw material he harvests himself, the mobile mini processing unit provides the capability for the harvester to include the raw material of nearby competitors, opening up a revenue stream that would not otherwise exist. The user of the present invention can charge a fee to process the competitor's raw material, or he can buy the raw material at market price, process it himself, and sell the semi-refined product at a higher price.

As an additional benefit, the mini processing units are far more efficient, modernized, and dean (extremely low carbon footprint) than a typical large refinery. The large and much older refining plants are considered polluters, and the only way they can reduce the heavy fines for their pollution is to purchase tax credits from “clean” process systems. For a U.S. producer, therefore, it is possible to sell tax credits as a reward for the reduction in environmental impact. This gives an oil field producer, for example, some long-needed leverage and extra revenue.

Foreign producers, particularly those in the third world, can benefit from the present invention as well, by being able to develop their own natural resources instead of relying on imports, or by refining their own materials and selling at a higher price.

The following table shows some of the process streams available to a user who is a driller of crude oil, as products of the topping unit. The first column defines six different process streams that can be produced by the Stage 1 topping units 13. The second column defines existing large refinery needs and uses for these streams, which makes them more valuable than the raw crude. The third column lists some of the other markets and industries for the field producer. These options are not currently available to the field producer, and are made available only through the use of the present invention.

| | Refinery Use | Non Refinery Use |
|---|---|---|
| Product | Most common market | Secondary Market(s) |
| LVN Light Virgin Naphtha | High volatility. Low octane | As solvents, for makers of |
| | number of about 70. Unsuitable | varnishes, paints etc. |
| | as motor fuel. Needs to be | Food industry to extract flavors, |
| | upgraded in a isomerization unit | chemicals, oils etc. |
| | to high octane blending stock. | Used in process of making |
| | Usually low sulfur so it can be | linoleum and rubber products |
| | blended into motor gasoline | |
| | pool up to the vapor pressure | |
| | land octane limit. | |
| | Used for blending into various | |
| | fuels up top flash limit. | |
| HVN Heavy Virgin Naphtha | Same as for LVN. Except that | Same as for LVN |
| | HVN is upgraded to a high | |
| | octane stock in a platinum | |
| | reformer plant (platformer or | |
| | reformer) | |
| Kerosene | In the USA needs to be hydro- | Basically as jet fuel or turbine |
| | treated to remove sulfur to be | fuel for gas turbines. Also for |
| | used as jet fuel or turbine fuel. | high efficiency combined cycle |
| | Outside of the USA the | power plants. |
| | regulations are much less | Used as a paint thinner as a |
| | rigorous depending on which | substitute for turpentine. |
| | country it is used in. | |
| Diesel | In the USA, Canada, European | As solvent to selectively extract |
| | Union, & Japan has to be hydro- | certain oils from biomass. |
| | treated in HDS units to ULSD | Rest of the world is rapidly |
| | Ultra Low Sulfur Diesel. Rest of | switching to ULSD for |
| | world is catching up really fast. | automotive use. |
| | Blending into fuel oils. | As fuel for rail road engines and |
| | | as marine fuel. For power |
| | | generation in gensets or gas |
| | | turbines. |
| Gasoil | Blending into fuel oil. | As cheap fuel for rail road |
| | Feed to a FCCU unit to increase | engines and as marine fuel. For |
| | gasoline production | power generation in gensets or |
| | | gas turbines. |
| Fuel Oil Bottoms | Feed to vacuum unit to produce | Fuel oil such as No 6 is rapidly |
| | heavy vacuum gasoil for feed to | disappearing as fuel in the USA |
| | FCCU unit for gasoline | and around the world due to |
| | production. | environmental concerns and the |
| | Lube oil extraction in vacuum | switch to cleaner burning natural |
| | unit. | gas. |
| | Feed to coking unit to make | |
| | gasoil and petroleum coke. | |
| | Blended into fuel oil or made | |
| | into asphalt | |

### The 2nd Stage

As the harvest site grows, certain producers might be in a position to go even further with the addition of an actual mini refinery 14. Mini refinery units 14 are designed and built according to the same philosophy as the preparatory stage systems; they are small, modular, and mobile units mounted on special trailers are sent to a designated area, set up, interconnected, and used to refine the various process streams generated by the initial preparatory stage units. As with the topping unit 13, as the refinery needs to grow, one or more simple plug-in modules can be added.

After refining, the producer has the option to sell to various distribution companies, or he can sell finished products (such as gasoline, diesel, jet fuel, etc.) directly on the NYMEX. In addition, he has the possibility of being granted an additional tax credit financial stream, as described above.

### The 3rd Stage

Certain producers might want to go even further after the refining stage. There are literally thousands of final products that can be produced in a wide variety of specialty units, following the same philosophy as the Stage 1 and 2 units. In addition, the system of the present invention provides the opportunity to set up a regional network.

Stage 1 preparatory units can be deployed over various fields and can supply partially refined products to a single Stage 2 local mini refinery, which in turn can supply basic refined products to Stage 3 finishing units 15, which produce specialized finished products as dictated by the market. For example, commercial-grade wax derived from basic crude oils that are high in paraffins can be produced using a specialized down-hole device.

As described above, the decentralization philosophy of the present invention, utilizing the mini-mobile build-as-needed approach, offers the maximum economic benefit for the producer in the field.

### The Distillation Unit

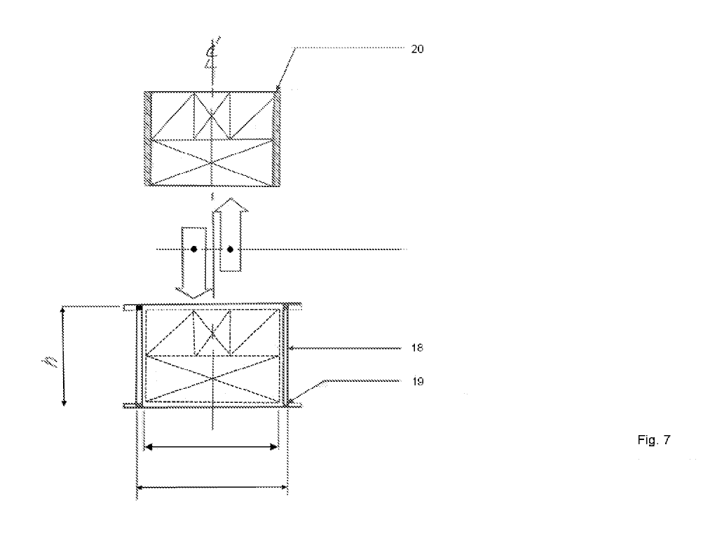

An exemplary Stage 1 mini unit to be used by the oil industry is the modular distillation tower. As shown in FIG. 6, a conventional distillation unit 16 is a very tall tower that is constructed as a single-piece unit (that is, an ASME Code Vessel). Crude oil must enter the tower at a temperature of about 650 degrees and go through an internal “obstacle course”, or distillation internal, that runs the full height of the vessel and that perform the distillation process. All the materials that form the obstacle course must be furnished in “knock down” condition, that is, they are provided in small sections. These sections enter through “manways” 17 and then have to be assembled inside the tower. This is very labor intensive as the work space is very tight. Men, materials and even lighting have to go into it, and then the entire system has to be reversed when maintenance is performed. Construction and maintenance are so expensive that the great majority of all small producers can't afford a tower, particularly if a producer doesn't yet pump enough oil to fill the tower in the first place.

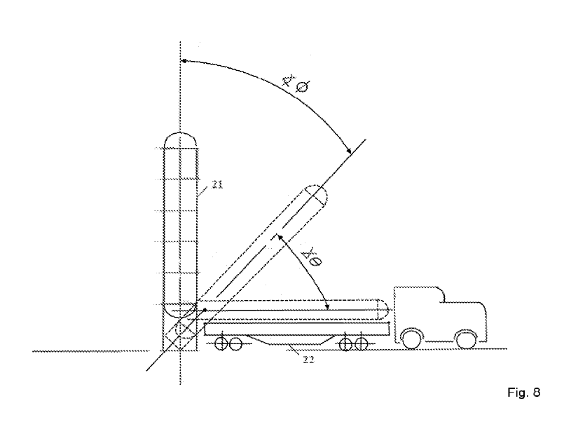

The distillation unit of the present invention includes a tower that is designed as a large diameter pipe that operates at atmospheric pressure, rather than as a pressure vessel. This design eliminates the manways required by the conventional design. As shown in FIG. 7, each pipe is a section 18 that is stackable; the user can start with a small unit, and then gradually build it up as his field production increases to justify a larger unit, with individual sections preferably connected using standard flange connectors 19. The internal obstacle course is insertable as a cartridge 20, and preferably already comes loaded within each section when it arrives in the field. To perform maintenance, a cartridge 20 is simply removed for cleaning and/or replacement. For simplicity, each cartridge 20 preferably is an exact duplicate of each other, with the overall obstacle course designed to be uniform and therefore the cartridges 20 are interchangeable for any elevation of the tower. This simple, modular, scalable, customizable design makes it economically feasible for a producer to have a distillation unit in the field.

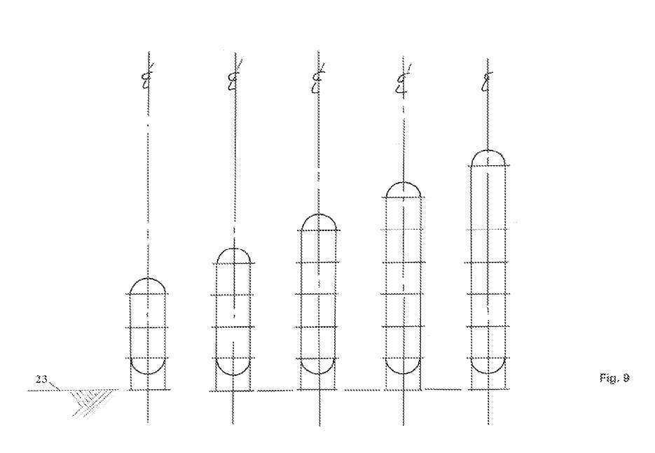

Many petroleum producers simply need to start refining their crude with a single modular unit, small enough to transport upright. As additional units are needed, these too would arrive in the same fashion. For producers having an amount of crude oil available in their field warranting more refining, a full, multi-module tower is mounted on a special trailer designed to carry the weight of the entire tower (including all internals), with the tower 21 transported on its side, as shown in FIG. 8. Then, once the tower 21 is delivered to the location at which it will be used, a special trailer mechanism 22 self-erects the entire tower 21 from its position on the trailer. Once bolted to its foundation 23 in the proper orientation, the distillation tower 21 is complete, ready to be piped up to the other equipment, and therefore ready for operation within a few days to a week.

As noted above, each cylindrical section is a stackable module and the number of modules is determined by the quantity of crude initially available for processing. This approach allows the oil producer to better plan when to drill more wells because, as more oil becomes available, additional modules are added to the top of the stack, as shown in FIG. 9, and a small amount of piping is rearranged, resulting in a quick and economical increase in processing capacity.

Each module section can be dedicated to a specific process stream, so that the production results are the same as with the usual one-piece tower. That is, each module section can have its own output port, so that the tower can provide a variety of products produced by various levels of distillation.

### The Rest of the 1st Stage System

The distillation tower is preferably mounted onto a concrete foundation 23, whereas other equipment need only be skid-mounted and then positioned onto flatbed trailers for delivery to the field as specialized packages. The trailers are positioned in designated areas of a concrete area. Once in position, the cabs are disconnected from the flatbed trailer(s). The usual trailer posts are then lowered onto the concrete surface (for support), then adjusted in height such that the wheels are lifted off the concrete surface. The number of trailers needed is dictated by the initial quantity and quality of the crude oil to be processed. Additional trailers can be added as plug-in modules if needed in future expansions.

Industry standard steel grating sections, (that is, decking), connects all trailers so as to provide a workable elevated platform for both men, tools, and some spare parts. The platform also allows vertical space below the decking to allow certain piping and cabling runs. With all trailers and decks in place, the final piping systems, valving, instrumentation, and electrical systems can then connect all of the equipment, forming a complete process plant, designed for automatic operation.

The present invention has been described by way of example and in terms of preferred embodiments. However, it is to be understood that the present invention is not strictly limited to the particularly disclosed embodiments. To the contrary, various modifications, as well as similar arrangements, are included within the spirit and scope of the present invention. The scope of the appended claims, therefore, should be accorded the broadest possible interpretation so as to encompass all such modifications and similar arrangements.

I claim:

1. A method of refining hydrocarbon material, comprising:
transporting a mobile refinery to a harvesting site;
at least partially refining raw hydrocarbon material at the harvesting site; and
transporting the at least partially refined hydrocarbon material to a remote location.

2. The method of claim 1, wherein the harvesting site is a drilling site.

3. The method of claim 2, wherein the drilling site is at least one of a crude oil drilling site and a natural gas drilling site.

4. The method of claim 3, wherein the raw hydrocarbon material is crude oil.

5. The method of claim 1, wherein the remote location is a refinery, and wherein the method further includes further refining of the at least partially refined hydrocarbon material at the refinery.

6. The method of claim 1, wherein the remote location is a saes distribution center.

7. The method of claim 1, wherein transporting the mobile refinery includes providing a miniature refinery module on a transport vehicle.

8. The method of claim 1, wherein transporting the at least partially refined hydrocarbon material includes providing a storage module on a transport vehicle.

9. The method of claim 1, wherein the harvesting site is located in an area remote from main pipeline access.

10. The method of claim 1, further comprising transporting the mobile refinery to a second harvesting site.

11. A hydrocarbon material refining system, comprising:
a mobile refinery adapted to be transported to a harvesting site and to at least partially refine raw hydrocarbon material at the harvesting site; and
a mobile storage module adapted to store the at least partially refined hydrocarbon material for transport to a remote location.

12. The system of claim 1, wherein the harvesting site is a drilling site.

13. The system of claim 2, wherein the drilling site is at least one of a crude oil drilling site and a natural gas drilling site.

14. The system of claim 3, wherein the raw hydrocarbon material is crude oil.

15. The system of claim 1, wherein the remote location is a refinery adapted to further refine the at least partially refined hydrocarbon material.

16. The system of claim 1, wherein the remote location is a sales distribution center.

17. The system of claim 1, wherein the mobile refinery includes a miniature refinery module disposed on a transport vehicle.

18. The system of claim 1, wherein the storage module is disposed on a transport vehicle.

19. The system of claim 1, wherein the harvesting site is located in an area remote from main pipeline access.

20. The system of claim 1, further comprising a second harvesting site.
